(19) United States
(12) Patent Application Publication
(10) Pub. No.: US 2017/0334738 A1
(43) Pub. Date: Nov. 23, 2017

(54) SOLAR DESALINATION PROCESS AND EQUIPMENT

(71) Applicant: Nam Pyo Suh, Sudbury, MA (US)

(72) Inventor: Nam Pyo Suh, Sudbury, MA (US)

(21) Appl. No.: 15/491,087

(22) Filed: Apr. 19, 2017

Related U.S. Application Data
(60) Provisional application No. 62/324,436, filed on Apr. 19, 2016.

(51) Int. Cl. C02F 1/14; F22B 1/00; B01D 5/00; F03G 6/06; H02J 7/35; H01M 10/46

(52) U.S. Cl. CPC C02F 1/14; H02J 7/35; H01M 10/465; B01D 5/006; F03G 6/06; F22B 1/006

(57) ABSTRACT

A system for desalination of salt water using solar energy. The system includes an inner channel for flow of salt water there through, the inner channel having a cover thereover that is water vapor impermeable yet UV transparent or transmissive. A collection channel for collecting clean water extends along the inner channel. By having the inlet of salt water to the inner channel elevated in relation to the outlet of salt water from the inner channel, the salt water flow naturally through the channel. A solar-powered pump can be used to provide the salt water to the inlet.

### CROSS-REFERENCE

This application claims priority to U.S. provisional application 62/324,436 filed Apr. 19, 2016 titled “Solar Desalination Process and Equipment,” the entire disclosure of which is incorporated herein by reference for all purposes.

### FIELD OF THE DISCLOSURE

The present disclosure is directed to systems and methods for desalinization of water using solar energy.

### BACKGROUND

Conventional desalination processes (such as reverse osmosis and vaporization processes) are highly energy intensive. For many countries that rely on desalinization of salt water (e.g., seawater) for their potable and otherwise fresh water, the cost of desalinating the water is equivalent to a large fraction of that country's GDP.

Various solar desalinization systems and processes have been designed and even implemented, but many are complicated and require high-tech equipment and/or materials.

Improvements in desalinization processes, particularly lower cost options, are needed.

### SUMMARY

The present disclosure provides a system for a low energy-intensity desalination process. Solar energy evaporates clean water from the salt water and the clean water is collected.

Provided is a solar desalination system having an inner channel for retention of water (e.g., salt water) therein, an outer chamber at least partially surrounding and preferably vaporly-sealing the inner channel, and a collection channel for collecting desalinated water. At least part of the system, particularly the inner channel, may be angled from a higher elevation to a lower elevation, with a first end (e.g., inlet) of the inner channel being at a higher elevation than a second end (e.g., outlet) of the inner channel to facilitate liquid flow from the first end to the second end. At the first end (e.g., inlet) of the inner channel, the concentration of salt in the water in the inner channel is lower than at the second (opposite) end (e.g., outlet) of the inner channel. The collection channel collects desalinated water condensed from vapor evaporated from the salt water in the inner channel.

This disclosure provides, in one particular implementation, a desalinization system. The system has an elongate body having a length; a first, heat insulative channel in the body extending the length and a second channel in the body extending the length parallel to the first channel, the first channel having a salt water inlet elevationally higher than a salt water outlet, and the second channel having a clean water outlet; a water vapor impermeable, UV transparent cover over the first channel and the second channel; and a solar powered pump fluidly connected to the salt water inlet.

This disclosure also provides, in another particular implementation, a method for desalinating water. The method includes providing salt water from a source to an inlet of a first channel having a length; flowing via gravity the salt water from the inlet along the length of the first channel; evaporating water from the salt water in the first channel and condensing the evaporated water on a water vapor impermeable, UV transparent cover; collecting the condensed water in a second channel; and removing salt water having a higher concentration of salt than the salt water from the source from an outlet of the first channel.

In some implementations, the system and/or the method requires no wired electrical source, but rather, any energy needed by the system and/or the method is solar provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWING

The disclosure may be more completely understood in consideration of the following detailed description of various implementations of the disclosure in connection with the accompanying drawing, in which:

FIG. 1 is a schematic side plan view of an installed solar desalinization system.

FIG. 2 is a schematic cross-sectional diagram of an example solar desalinization channel.

FIG. 3 is a schematic cross-sectional diagram of another example solar desalinization channel.

### DETAILED DESCRIPTION

The present disclosure is directed to a low energy-intensity desalination process. In general, the disclosure provides a desalination system that relies on energy from the sun (solar energy) to desalinate water (e.g., salt water, such as seawater). The system includes a channel having an inner channel for receiving salt-containing water therein, and an outer chamber at least partially surrounding and preferably sealing the inner channel in a manner to control water (including evaporated water, e.g., moisture).

The system, or at least the inner channel, may be angled from a higher elevation to a lower elevation, with a first end (e.g., inlet) of the inner channel being at a higher elevation than a second end (e.g., outlet) of the inner channel. At the first end (e.g., inlet) of the inner channel, the concentration of salt in the water is lower than at a second (opposite) end (e.g., outlet) of the inner channel.

It should be understood that although the term “salt water” is used herein, varying levels of salt may be present in the water or other liquid carrier, thus including other water sources, such as, e.g., brackish water. Further, although the term “seawater” or “sea” may be used, other sources for the water may be used, such as an ocean, river, channel, holding tank, etc.

Additionally, it should be understood that the terms “desalinization” and variations thereof and “desalination” and variations thereof are interchangeable and no inference should be made by the use of one versus the other.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

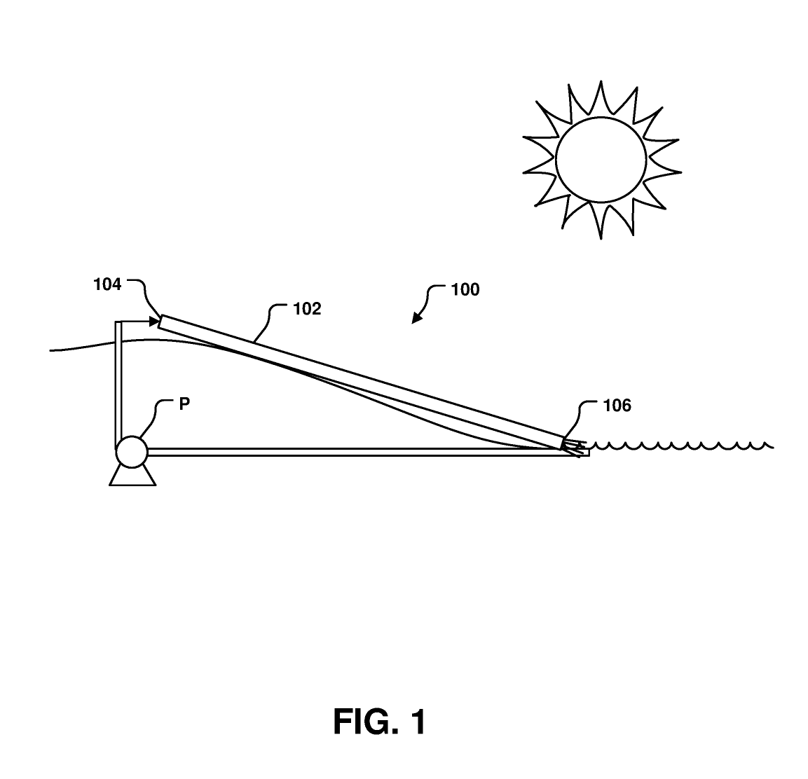

FIG. 1 illustrates a desalination system 100 of the present disclosure. The system 100 has an elongate body 102 having a first end 104 and an opposite second end 106. Not seen in FIG. 1, the body 102 has an interior volume having a channel therein extending from the first end 104 to the second end 106 for receiving liquid (e.g., salt water) therein. In FIG. 1, the first end 104 is an inlet end and the second end 106 is an outlet end, due to the orientation of the system 100 inclined on a hill with the first end 104 elevated above the second end 106. The first end 104 may be open, having no wall or other liquid retaining structure perpendicular to, orthogonal to, or otherwise extending across the body 102. The second end 106 is close to, or immediate adjacent to or above, a source of salt water, such as an ocean, sea, canal, holding pond, etc.

In an alternate set-up, rather than having the system 100 located on a natural topographical feature such as a hill, the system 100 may be provided on a ramp or other incline to provide an elevation change from the first end 104 to the second end 106. The incline may be incorporated into the system 100, e.g., into the body 102. In some implementations, the system 100 may be portable, for example, mounted on a portable, inclinable transport. Further, although FIG. 1 has the system 100 close to a source of salt water, in alternate implementations the salt water may be run to and/or from the system 100 in any conduit such as hoses, channels, pipes, aqueducts, etc.

Salt water is received into the system 100 via the first end 104, for example, pumped from the source by a conventional liquid pump P. In some implementations, the pump P may be an electro-mechanical pump powered by solar or wind power, or by a battery, thus not requiring wiring to an A/C source and allowing the system 100 to be installed in remote locations, although in other implementations the pump P may be electric (A/C) operated. Salt water, provided via the pump P, runs from the first end 104 through the body 102 to the second end 106 due to the incline of the body 102. The residence time of the salt water in the body 102 is dependent on the incline of the body 102. As the salt water progresses from the first end 104 to the second end 106, desalinization of the salt water occurs, resulting in non-salted water and salt water with increased salinity exiting at the second end 106. In some implementations, the salt water with increased salinity dumps directly back into the salt water source. The clean water (condensed water having little or no salt) is collected for use.

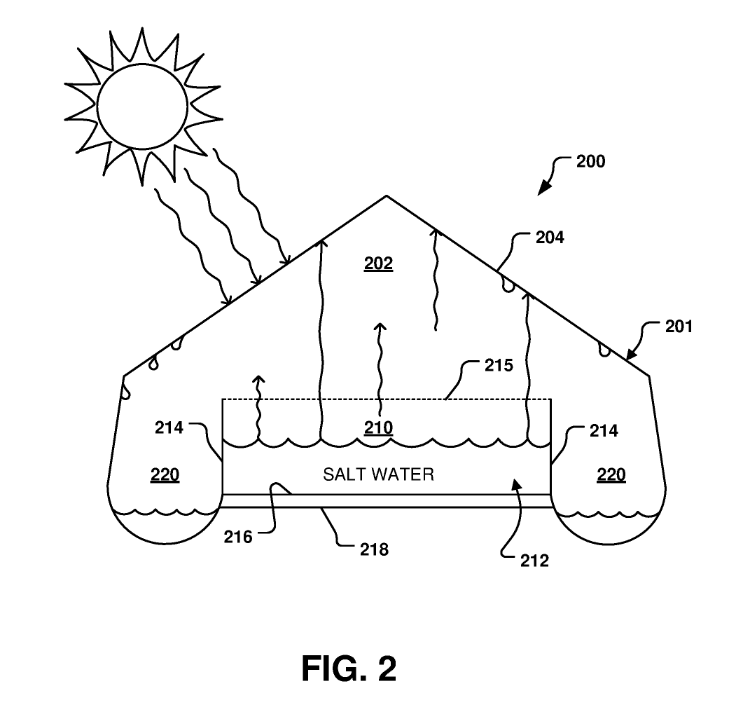

Turning to FIG. 2, a desalinization system 200 is shown in schematic cross-section. The desalinization system 200 has an elongate body 201 that has an interior volume 202. The body 201 has a first end and a second end (not seen in FIG. 2) that are an inlet and an outlet from the interior volume 202. The interior volume 202 is defined at least partially by a water vapor impermeable, yet solar energy penetrable, cover 204. The cover 204 may be sloped or angled.

The cover 204 is formed of a material that allows solar energy (e.g., heat) to access the inner channel. Examples of suitable materials for the cover 204 include materials that are transmissive to any or all of UV radiation, visible light, UV light; the materials may be visibly transparent, translucent, or semi-opaque, or even opaque. The materials may be flexible, such as polymeric film, or may be rigid, such as polycarbonate or glass.

As seen from the cross-sectional view of FIG. 2, present in the interior volume 202 is an inner channel 210, that extends from essentially the first end to the second end of the body 201. The cover 204, in the illustrated implementation of FIG. 2, fully encloses the inner channel 210, however in some implementations some venting may be present. The inner channel 210 has a volume 212 for receiving salt water therein, the channel 210 defined by side walls 214, a bottom 216, and, in this implementation, a water vapor permeable top 215. In some implementations, the inlet end of the inner channel 210 is open, thus creating an inner channel 210 that will not retain liquid if the inner channel 210 was not elevated with the inlet end higher than the outlet end. Present proximate the bottom 216 is a heater 218, in thermal communication with the inner channel 210. The heater 218 may be powered by solar or wind power, or by a battery, thus not requiring wiring to an A/C source, although in some implementations the heater 218 may be connected to an A/C source.

The inner channel 210 (e.g., the walls 214 and the bottom 216) can be formed from any material conducive to resisting corrosion and other degradation due to high salt exposure. At least part of the inner channel 210 (e.g., the walls 214 and/or the bottom 216) is formed from a material that accepts and retains solar energy (heat), such as a black or other dark or heat absorbent material, and/or which is at least semi-insulative. In some implementations, only the bottom wall 216 of the inner channel is black (or other dark color), although in other implementations the side walls 214 are also black (or other dark color).

Also present in the interior volume 202 is at least one collection channel 220 for collecting desalinated water, in this particular implementation, one collection channel 220 on each side of the inner channel 210, extending the length of the inner channel 210. The collection channels 220, in this implementation, share side walls 214 with the inner channel 210 and are adjacent and parallel to the inner channel 210. In other implementations, the collection channel(s) 220 may have a unique side wall.

Various flow diverters, controllers (e.g., ripples, baffles, etc.), fluid flow enhancers (e.g., coatings, microfeatures, etc.) may be present in either or both the inner channel 210 and the collection channels 220 to modify the flow of salt water or clean (desalinated) water, respectively, and/or to increase the residence time of the salt water in the inner channel 210.

The cover 204 can also fully enclose the collection channels 220, however in some implementations some venting may be present. The cover 204 is inclined, being higher over the inner channel 210 than over the collection channels 220.

In operation, salt water is provided to the inner channel 210, typically at the first end of the inner channel 210, which is inclined in relation to the second end to establish a natural flow of salt water due to gravity from the first end to the second end. The degree of incline affects the residence time of the salt water in the channel 210, and in some implementations, baffles, holding trays, and/or other physical obstructions may be present in the channel 210 to increase the residence time. The inner channel 210 may have a wall or partial wall at the second (discharge) end of the body, to further increase the residence time. The incline, in some implementations, may be negligible, e.g., less than 1 degree. The salt water may be provided to the inner channel 210 only at an end inlet (e.g., the first end) or may be added to the inner channel 210 at multiple locations along its length.

The salt water then flows along the inner channel 210 from the first end to the second end, due to the first end having a high elevation that the second end. As the salt water flows down the inner channel 210, it is heated by solar energy that is provided to the salt water in the inner channel 210 through the cover 204. Additionally, the walls 214 and/or bottom 216 may absorb some of the energy (e.g., particularly if the walls 214 and/or bottom 216 are dark in color). In some implementations, the cover 204 may include a radiation or light enhancer, to increase the amount of energy passing through the cover 204 to the salt water in the channel 210. The heater 218 can further increase the temperature of the salt water in the inner channel 210.

As the vapor pressure builds up above the flowing water, corresponding to the temperature of the water in the heated inner channel 210, water vapor, essentially void of salt, evaporates from the salt water and escapes from the inner channel 210 through the vapor permeable top 215.

When the outside temperature surrounding the system 200 is less than the temperature of the interior volume 202 (e.g., after sunset), the water vapor condenses on the inside wall of the water vapor impermeable cover 204. As an example, vapor accumulated during the daytime condenses at night. The condensed water vapor will condense and coalesce on the cover 204, and eventually drip down and accumulate in the side channels 220. As indicated above, the cover 204 can be sloped to facilitate the collection of the condensate in the channels 220; in some implementations, the cover 204 may include a coating or features such as microfeatures to facilitate the condensation and/or collection of droplets.

The side channels 220 collect the water from where it is harvested, for example, in a reservoir or other tank. This desalinated water in a reservoir or collection tank can be later pumped to the final user of the water.

The concentration of salt in the collected water in the channels 220 will be essentially negligible along the length of the system 200, however the concentration of the salt in the salt water in the inner channel 210 will increase from the first end to the second end of the channel 210, as unsalted water is removed from the salt water along the length of the channel 210.

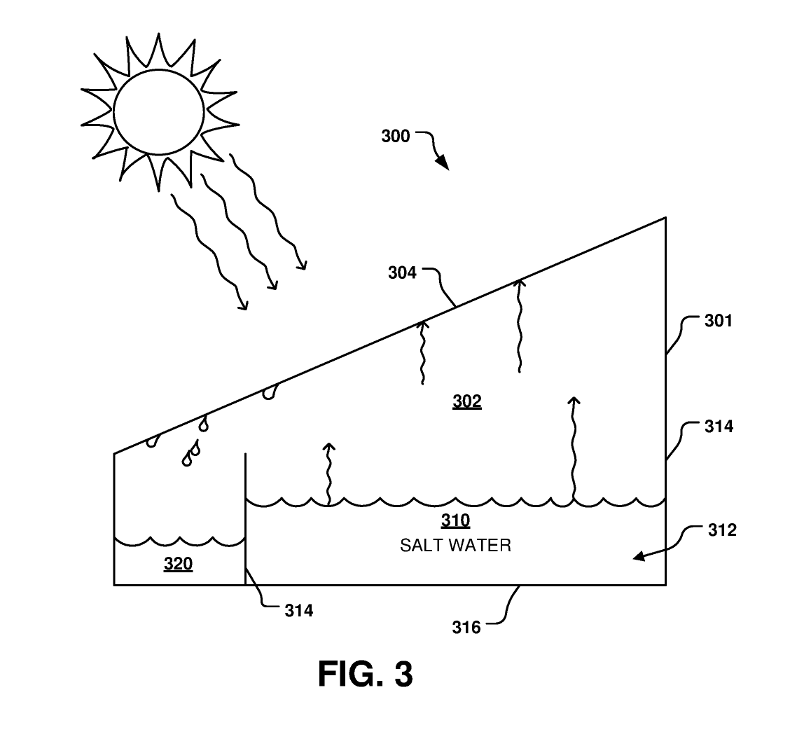

Turning to FIG. 3, another desalinization system, system 300, is shown in schematic cross-section. Similar to the previous system, the desalinization system 300 has an elongate body 301 with a first end and a second end (not seen in FIG. 3) that has an interior volume 302. The interior volume 302 is defined at least partially by a sloped or angle, water vapor impermeable, yet solar energy penetrable, cover 304.

Present in the interior volume 302 is an inner channel 310 that extends from essentially the first end to the second end of the body 301. The cover 304, in the illustrated implementation of FIG. 3, fully encloses the inner channel 310, however in some implementations, venting may be present. The inner channel 310 has a volume 312 for receiving salt water therein, the channel 310 defined by side walls 314 and a bottom 316.

The walls 314 and the bottom 316 can be formed from any material conducive to high salt exposure and additionally or alternately be formed from a material that accepts and retains solar energy (heat), such as a black or dark material that is at least semi-insulative.

Also present in the interior volume 302 is at least one collection channel 320 extending the length of the inner channel 310. The collection channel 320, in this implementation, shares the side wall 314 with the inner channel 310.

It is understood that features of the various desalinization systems described and disclosed herein can be interchanged, and that one system can include features from the other system, as appropriate. Details regarding one system are understood to be applicable to the other system.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Also as used herein, when the phrase “at least one of” is used in conjunction with any of “and”, “or”, and “and/or” what is intended is that the phrase “at least one of X, Y or Z” encompasses, for example: one X; one Y; one Z; one X and one Y; two Xs; etc., unless the context specifically indicates otherwise.

Since many implementations of the invention can be made without departing from the spirit and scope of the invention, the invention resides in the claims hereinafter appended. Furthermore, structural features of the different implementations may be combined in yet another implementation without departing from the recited claims.

I claim:

1. A desalinization system comprising:
an elongate body having a length;
a first, heat insulative channel in the body extending the length and a second channel in the body extending the length parallel to the first channel, the first channel having a salt water inlet elevationally higher than a salt water outlet, and the second channel having a clean water outlet;
a water vapor impermeable, UV transparent cover over the first channel and the second channel; and
a solar powered pump fluidly connected to the salt water inlet.

2. The system of claim 1 wherein the cover is inclined from over the first channel to over the second channel.

3. The system of claim 1 wherein the cover is sealed and non-vented over the first channel and the second channel.

4. The system of claim 1 wherein the first channel has a first end and an opposite second end, and the salt water inlet is at the first end and the salt water outlet is at the second end.

5. The system of claim 4 wherein the first channel has a second salt water inlet positioned between the first end and the second end.

6. The system of claim 4 wherein the first end of the first channel has no structure to retain the salt water.

7. The system of claim 1 wherein the first channel comprises a heat absorbent color.

8. The system of claim 1 further comprising a third channel parallel to the first channel, the third channel having a clean water outlet.

9. The system of claim 8, wherein the first channel extends between the second channel and the third channel.

10. A method of desalinating water comprising:
providing salt water from a source to an inlet of a first channel having a length;
flowing via gravity the salt water from the inlet along the length of the first channel;
evaporating water from the salt water in the first channel and condensing the evaporated water on a water vapor impermeable, UV transparent cover;
collecting the condensed water in a second channel; and
removing salt water having a higher concentration of salt than the salt water from the source from an outlet of the first channel.

11. The method of claim 10 wherein flowing via gravity the salt water comprises flowing the salt water from the inlet that is elevationally higher than the outlet.

12. The method of claim 10 wherein removing salt water having a higher concentration of salt than the salt water from the source comprises returning the salt water having a higher concentration of salt than the salt water from the source to the source.

13. The method of claim 10 wherein providing salt water from the source to an inlet comprises pumping the salt water with a solar-powered pump.

14. The method of claim 10 wherein:
evaporating water from the salt water in the first channel occurs during daylight hours and condensing the evaporated water on the water vapor impermeable, UV transparent cover occurs after sunset.
